(19) United States
(12) Patent Application Publication
(10) Pub. No.: US 2021/0278528 A1
(43) Pub. Date: Sep. 9, 2021

(54) GROUND BASED SYNTHETIC APERTURE RADAR (GBSAR) WITH TRANSMITTING AND RECEIVING MULTIPLE ANTENNAS (MIMO) AND USING THE PROCESSING TECHNIQUE CALLED COMPRESSIVE SENSING (CS)

(71) Applicant: UNIVERSITA' DEGLI STUDI DI FIRENZE, Firenze (IT)

(72) Inventors: Massimiliano PIERACCINI, Firenze (IT); Lapo MICCINESI, Firenze (IT); Neda ROJHANI, Firenze (IT)

(21) Appl. No.: 17/255,833

(22) PCT Filed: Jun. 27, 2019
(86) PCT No.: PCT/IB2019/055448

§ 371 Date: Dec. 23, 2020

(30) Foreign Application Priority Data
Jun. 29, 2018 (IT) 102018000006797

(51) Int. Cl. G01S 13/90

(52) U.S. Cl. CPC G01S 13/9023

(57) ABSTRACT

Ground radar apparatus comprising: at least a main radar unit (U) provided with at least a transmitting unit (TX) and at least a receiving unit (RX); two parallel linear guides G1 and G2 with antenna securing systems; N_{TX} antennas connected to the transmitting unit TX; N_{RX} antennas connected to the RX transmitting unit. This radar is a MIMO (Multiple Input Multiple Output) that operates as an interferometric GBSAR (Ground Based Synthetic Aperture Radar) exploiting a particular implementation of the processing technique called Compressive Sensing (CS). In a further configuration of the same radar the parallel linear guides are three, in this way it is possible to acquire two different interferograms of the same scenario that allow to calculate two different components of the possible displacement of the targets.

### FIELD OF THE INVENTION

The invention relates to a synthetic aperture radar and in particular a ground based radar employed for remote sensing of target displacements.

### BACKGROUND ART

The interferometric Ground Based Synthetic Aperture Radar (SAR) (GBSAR: Ground Based Synthetic Aperture Radar) have long been known and widely used for monitoring landslides and large structures such as reported in Tarchi D. at al. “Landslide monitoring by using ground based SAR interferometry: An example of application to the Tessina landslide” Engineering Geology, Vol. 68, no. 1-2, February 2003, pp. 15-30.

Such radars use a pair of antennas (respectively transmitting and receiving) which moves along a mechanical guide to acquire a radar image synthesizing a virtual opening equal to the scanning length.

Interferometric GBSAR systems based on a MIMO (Multiple Input Multiple Output) architecture are also known.

An example of such systems is reported in Tarchi D. et. al. “MIMO radar and ground based SAR imaging systems: equivalent approaches for remote sensing.” IEEE Transactions on Geoscience and Remote Sensing, Vol. 51, no. 1, pp. 425-435, 2013. Such radar is based on a particular regular arrangement of the transmission and receiver antennas designed to minimize the side lobes (grating lobes).

It is also known a processing technique called Compressive Sensing “CS” (see for example Baraniuk, R. G. “Compressive sensing IEEE signal processing magazine, Vol. 24, no. 4, pp.118-121, 2007) applied to data acquired by a conventional GBSAR as reported in Zonno, M. “GBSAR data focusing based on compressive sensing.” In EUSAR 2014; 10th European Conference on Synthetic Aperture Radar; Proceedings of (pp. 1-4). 2014.

The application of CS to GB-SAR systems is also described in Riafeni Karlina et al.: “Compressive Sensing applied to imaging by ground based polarimetric SAR”—Geoscience and Remote Sensing Symposium (IGARSS)—2011 IEEE International, 24 Jul. 2011—pages 2861-2864.

The CS technique was also recently used in a MIMO GBSAR as described in M. Sato, “2-D and 3-D near range SAR imaging.” in Antenna Measurements & Applications (CAMA), 2017 IEEE Conference on, pp. 157-160 e in W. Feng, L. Yi, M. Sato “Near range radar imaging by SFCW linear sparse array based on block sparsity” 2017 IEEE International Geoscience and Remote Sensing Symposium (IGARSS), 23-28 Jul. 2017 DOI: 10.1109/IGARSS.2017.8128215). However, this system uses a conventional distribution of antennas and applies the CS technique in order to reduce the number of frequencies, not the number of antennas as in the invention subject of this patent.

### OBJECT OF THE INVENTION

A first object of the invention is to propose a MIMO GBSAR system with a reduced number of antennas, capable of overcoming the drawbacks of mechanical scanning GBSAR systems of the known type, speeding up the acquisition time of the images and the drawbacks of the current MIMO GBSAR which have strong side lobes due to the regular spacing of the antennas.

A second object is to propose a MIMO GBSAR system capable of measuring two different components of the displacement of a target in the radar field of view.

### SUMMARY OF THE INVENTION

To these purposes according to the invention a system is proposed according to at least one of the appended claims, comprising a ground based synthetic aperture radar (GBSAR) with an irregular distribution of multiple transmitting and receiving directional antennas (MIMO) which uses an image processing technique comprising an algorithm of the CS (Compressive Sensing) type.

A first advantage of the invention with respect to known MIMO GBSAR systems is the reduction in the number of antennas with equal performances in terms of angular resolution and to allow to obtain images not affected by the problem of the side lobes (grating globes).

A second advantage with respect to the known MIMO GBSAR is that it is possible to use larger and therefore more directional antennas.

A second advantage is given by the fact that, in a particular configuration of the radar object of this invention it is possible to acquire two images of the same scenario taken from two different points of view and measure two different components of the possible displacement of the targets in the field of view.

### LIST OF DRAWINGS

These and other advantages will be better understood by a person skilled in the art from the description below and the accompanying drawings, wherein:

FIG. 1 schematically shows the radar object of the invention.

FIG. 2 shows a radar according to the invention in which the TX antennas are arranged along a linear guide G1 and the RX antennas are arranged along a guide G2;

FIG. 3 shows the arrangement of the acquisition points in the radar of FIG. 2;

FIG. 4 shows a further configuration of a radar according to the invention.

### DETAILED DESCRIPTION

With reference to the attached drawings, the transmission and reception unit U is connected by means of two switch systems (also called SPNT: Single Pole N− through) SW1 and SW2 respectively to N_{TX} transmitting antennas and N_{RX} receiving antennas. Similarly, each switch system can be replaced by SPDT pairs (SPNT: Single Pole Double through) arranged as a tree.

Similarly, the receiving switch system can be replaced by N_{RX} receivers operating in parallel.

Similarly, the transmitting switch system can be replaced by N_{TX} waveform division transmitters as is typical of many MIMO systems (see for example J. J .M. De Wit, et al. “Orthogonal waveforms for FMCW MIMO radar.” In Radar Conference (RADAR), 2011 IEEE, pp. 686-691, 2011).

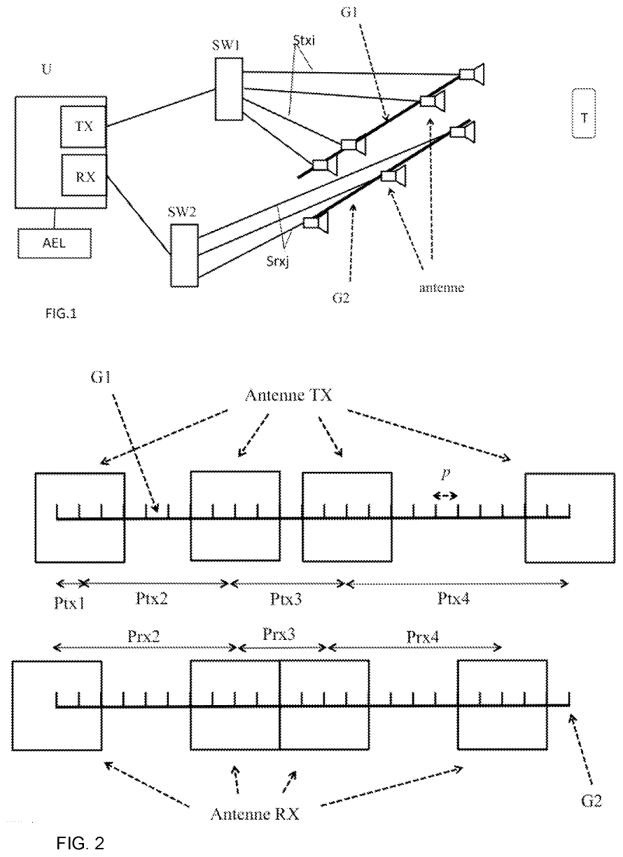

The radar object of this invention is based on a particular distribution of the transmitting (TX) and receiving (RX) antennas which are described below. With reference to FIG. 2, the TX antennas are arranged along a linear guide G1. The RX antennas are arranged along a second linear guide G2.

The two guides are parallel. Along the two guides antennas can be secured on positions regularly arranged with pitch p. In a preferred embodiment of the invention such pitch is equal to half of the radar wavelength (λ/2). A N_{TX} number of transmitting antennas are arranged with a random irregular distribution, in the relative guide G1. A number N_{RX} of receiving antennas are arranged with a random irregular distribution in the relative guide G2.

The acquisition takes place as follows:

A single TX antenna is turned on and is acquired (simultaneously or in succession) from all the RX antennas. This process is repeated for all the TX antennas, thus obtaining N_{TX}×N_{RX} signals or acquisition data Srxij.

For each of these Srxij data a virtual acquisition point PVAij can be associated at the median point between the centre of the TX antenna and the centre of the RX antenna.

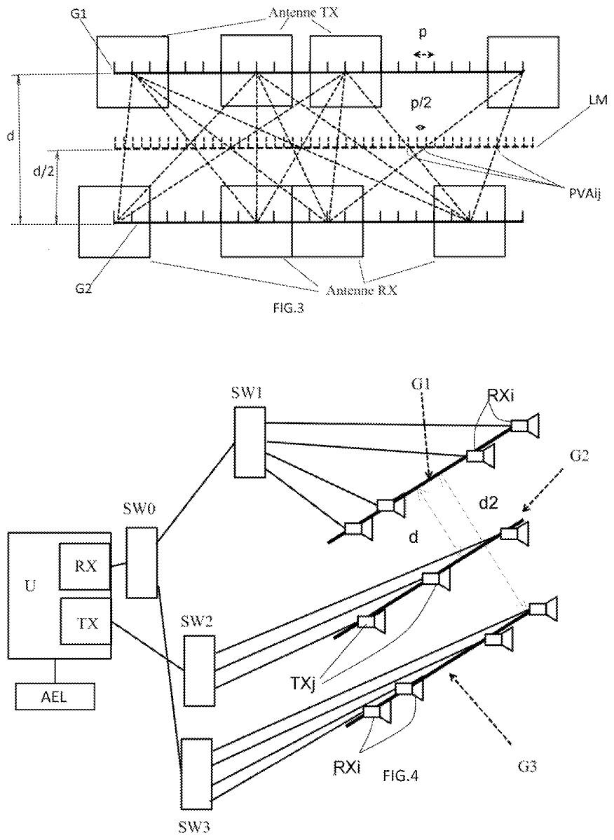

All these points will be on a line LM at the median distance between guide G1 and guide G2 (see FIG. 3).

Based on the position of these points on the median line, the so called psi array ((p) is constructed which will be used for CS processing. The construction of the psi array is performed as described below.

The number of columns K of the array is equal to the average length of the guides G1 and G2 divided by half of the pitch p. The number of rows M is arbitrarily chosen, but it is advisable to be equal to N_{TX}×N_{RX}.

All elements of all columns that do not correspond to a median point of a pair of TX and RX antennas are set to zero. The other elements of the array are filled with random numbers.

The array thus obtained is used to reconstruct (by means of the known technique CS) the values of the electric field acquired by K virtual antennas positioned along the median line between the G1 and G2 guide.

Acquisitions performed with K virtual antennas can be treated as the acquisitions of a conventional GBSAR moving along a line. Synthetic Aperture Radar (SAR) and radar interferometry known techniques can be applied to these data for the measurement of small displacements. In practice to measure the displacements (even millimetric) of a target in the field of view of the radar, two acquisitions are made in succession by transmitting and receiving from all antennas. The interferogram between the two obtained radar images is then calculated.

In a further configuration of the same radar (see FIG. 4) there are three parallel linear guides (G1, G2, G3), so it is possible to acquire two different interferograms.

The first interferogram is obtained using the antennas on G2 as transmitting and the antennas on G1 as receiving.

The second interferogram is obtained using the antennas on G2 as transmitting and the antennas on G3 as receiving. The two interferograms provide two different components of the possible displacement of the targets in the field of view.

The present invention has been described according to preferred embodiments; however, equivalent variants can be conceived without departing from the scope of the invention.

1. Ground based synthetic aperture radar apparatus comprising
a transmission and reception unit,
a number of directional transmitting antennas comprising at least three transmitting antennas operatively connected with the transmission and reception unit to transmit each one to a target arranged in the radar field of view a radar transmission signal of determined wavelength the transmitting antennas being arranged one after the other along a first linear guide with irregular spacings of amplitude equal to different multiples of a pitch,
a number of directional receiving antennas operatively connected with the transmission and reception unit to receive each one a number of wavelength reception signals of said determined wavelength from the target and corresponding to said transmission signals transmitted by said transmitting antennas,
said receiving antennas being arranged one after the other along at least a second linear guide parallel at a given distance with respect to said first guide, with successive irregular spacings of amplitude equal to different multiples of said pitch;
an electronic acquisition and processing unit operatively connected to said transmission and reception unit to:
acquiring said reception signals,
associating said reception signals with a virtual acquisition point arranged in a median position between the center of the transmitting antenna and the center of the receiving antenna,
constructing an array of elements based on the position of the virtual acquisition point points the array having a number of columns and a number of rows,
wherein in said construction step of the array all the elements of all the columns of order not corresponding to the position on the median line of an acquisition virtual point are set equal to zero and the other elements of the array are filled with random numbers;
processing said elements of the array by means of a compressive sensing algorithm applied to the array to reconstruct the values of the electric field acquired from a virtual array consisting of all the points along the line,
processing said electric field values by means of Synthetic Aperture techniques to obtain at least one radar image of said target corresponding to the acquisition of said reception signals.

2. Ground based synthetic aperture radar apparatus according to claim 1, wherein said number of receiving antennas comprises further receiving antennas arranged along a third linear guide parallel at a determined distance with respect to said first guide, with irregular spacings of amplitude equal to different multiples of said pitch, wherein said one electronic acquisition and processing unit is operatively connected to said transmission and reception unit to make two successive acquisitions and acquire two different interferograms, the first using said transmitting antennas arranged on the first linear guide said receiving antennas arranged on the second guide, the second using said transmitting antennas arranged on the first linear guide and said receiving antennas arranged on the third guide so that the two interferograms provide two different components of the possible displacement of the targets in the field of view.

3. Apparatus according to claim 1, wherein said first linear guide and said second linear guide are of equal length.

4. Apparatus according to claim 2, wherein the third linear guide and said first linear guide and said second linear guide are of equal length.

5. Apparatus according to claim 1, wherein said number of columns is equal to the average length of the first and second linear guides and divided by half the pitch.

6. Apparatus according to claim 1, wherein said number of rows is equal to the product of said number of directional transmitting antennas and said number of directional receiving antennas.

7. Apparatus according to claim 1, wherein said pitch is equal to half the wavelength of the ground based synthetic aperture radar.

8. Ground based synthetic aperture radar apparatus according to claim 1, wherein the transmitting antennas are exchanged with the receiving antennas using the antennas on the second linear guide as transmitting and the antennas on the first linear guide as receiving.

9. Apparatus according to claim 1, wherein said transmission and reception unit is connected by switch systems respectively to one or more transmitting antennas and to or more of the receiving antennas.

10. Apparatus according to claim 1, wherein said transmission and reception unit is connected to pairs of switches of the SPDT type arranged as a tree to one or more transmitting antennas and/or to one or more receiving antennas.

11. Apparatus according to claim 1, wherein said transmission and reception unit is connected in parallel to one or more of said receiving antennas.

12. Apparatus according to claim 1, wherein said transmission and reception unit is connected to one or more of said transmitting antennas by waveform division transmitters.
